(19) United States
(12) Patent Application Publication
(10) Pub. No.: US 2011/0263174 A1
(43) Pub. Date: Oct. 27, 2011

(54) NOVEL COMPOSITE MATERIALS, METHOD FOR THEIR PRODUCTION AND THEIR USE FOR THE FLOORING SECTOR

(76) Inventors: Michael Ketzer, Collenberg (DE); Klaus Friedrich Gleich, Highlands Ranch, CO (US)

(21) Appl. No.: 13/080,748

(22) Filed: Apr. 6, 2011

(30) Foreign Application Priority Data
Apr. 8, 2010 (DE) 10 2010 014 187.9

(51) Int. Cl. D04H 13/00; B32B 37/02; B32B 3/26

(52) U.S. Cl. 442/327; 428/304.4; 156/307.1

(57) ABSTRACT

The invention relates to novel sound-insulating composite materials, which are in particular suitable as materials for the flooring sector and for interior work.

The composite material according to the invention comprises at least one textile fabric in addition to suitable support materials, the textile fabric being end-consolidated by means of a B-stage binder and having cavities which correspond to a pore volume in the region of more than 20%.

### BACKGROUND OF THE INVENTION

The invention relates to novel sound-insulating composite materials, which are in particular suitable as materials for the flooring sector and for interior work.

Composite materials are increasingly replacing traditional building materials as construction materials and must be adapted for a wide range of applications. So, on the one hand, a satisfactory mechanical stability is demanded and, on the other hand, a good workability and low weight are required. Therefore, there has not been a lack of attempts to further improve existing composite materials.

Thus, it is already known to combine wood materials, which are produced from comminuted wood and the use of binders, with further materials. To this end, the two materials are conventionally laminated and form a composite material. By means of the selection and combination of the materials, the mechanical properties can therefore be improved and at the same time, a reduction, for example of the weight, can be achieved.

Composite materials based on wood materials and non-wovens, which are consolidated by means of a “B stage” binder, are already known for example from WO2006/031522. The underlying non-wovens with B stage binders are already fundamentally known for example from U.S. Pat. Nos. 5,837,620, 6,303,207 and 6,331,339.

Composite materials which contain a textile surface provided with a B-stage binder are described in WO08/101678. The composite materials described do not however offer any particular noise-damping properties which may appear to make them appear suitable for the flooring sector in particular.

Particularly in the flooring sector or in the case of laminate floors, good impact sound insulation and noise insulation are also required however in addition to the mechanical properties mentioned. Sound which arises due to the movement of people on a floor and is perceived in another room located next-door, therebelow or thereabove due to structure-borne sound transmission is designated as impact sound. Airborne sound is to be differentiated therefrom.

For impact sound insulation, a floor construction with screed complemented by damping fibreboards, foams or non-wovens is conventionally chosen.

The requirements on impact sound insulation are regulated in Germany by DIN 4109 “Sound insulation in buildings”

Although the insulating layers available on the market solve the problem of noise insulation for the floor underlay quite well in many cases, in that the noise transmission to the floor underlay is minimised, impact sound propagation and noise transmission into the room is exceptionally unsatisfactory, as before.

Airborne sound in particular, that is to say sound arising due to the travelling of a person on the floor, which can be perceived in the same room (possibly in a disturbing manner), is to be differentiated from the term introduced in architectural acoustics of impact sound, which designates sound perceived in other rooms. The airborne sound arising is primarily dependent on the properties of the surface of the floor (hard, soft) and the material damping of the floor.

Due to the distribution of hard floors (e.g. laminate), which has grown strongly internationally, disturbance due to airborne sound has increased recently. The capacity to minimise airborne sound or to produce less airborne sound has become an important feature for floors of this type. It is to be noted in this case that many commercially available impact-sound insulating underlays have no minimising or even have an amplifying effect on the airborne sound.

### SUMMARY OF THE INVENTION

Thus, one object of the invention is to enhance the already known products with regards to their application properties, particularly the impact sound and airborne sound damping and noise insulation, as well as the production processes.

The previously mentioned, and also further inherently necessary objects, are achieved by means of an improved composite material, the acoustic damping behaviour of which is improved.

The subject matter of one embodiment of the present invention is a composite material with improved acoustic damping behaviour, a method for its production and also its application and use.

The composite material according to the invention comprises
(i) at least one support material and
(ii) at least one textile fabric, the textile fabric having at least one end-consolidated B stage binder, characterised in that
(iii) the textile fabric end-consolidated with B-stage binders has cavities which correspond to a pore volume of more than 20%.

### DETAILED DESCRIPTION OF THE SPECIFIC EMBODIMENTS

The textile fabric present in the composite material according to the invention is constructed in such a manner that, in the finished product, cavities with a certain pore volume are present, which influence the sound propagation or the sound frequency. These cavities are produced in that the textile fabric has an end-consolidated B-stage binder portion which is too small for a pore-free curing, so that a pore volume, preferably a free pore volume, remains. The quantity of the end-consolidated B-stage binders used here is conventionally up to 35% by weight, preferably between 15% by weight and 20% by weight, (in each case based on the pre-consolidated textile fabric without functional materials which may be present).

The pore volume according to the invention is preferably a free pore volume, that is to say pores are filled with air or other gases or the pore volume according to the invention can also be achieved by means of the addition of acoustically active fillers, that is to say fillers which effect a sound absorption. In this case, the portion of the B-stage binder is higher, preferably between 60% by weight and 80% by weight and the pore volume is more than 20%. It has been shown that the textile fabric can also comprise paper, particularly when using acoustically active fillers.

The pore volume according to the invention can be determined by means of conventional porosity methods. Preferably, the free pore volume is determined by means of mercury porosimetry. This method allows the determination of mesopores and macropores. Pores <2 nm are understood to be microporous, mesoporous comprises pore sizes between 2 and 50 nm and macroporous comprises pores >50 nm.

A suitable mercury porosimeter consists for example of a Pascal 140/240 device with a pressure range of 0.013 to 0.4 MPa for determining the macropores and Pascal 140/440 with a pressure range of 0.1 to 400 MPa for determining the mesopores (Thermo Electron Corporation, Milan, Italy).

The pore size distribution is determined by measuring the volume of mercury which makes it into the pores under pressure. These form the free pore volume. As the pores are not precisely cylindrical however, as assumed in the equation, the calculated pore volumes and distributions can deviate from the real values.

Insofar as the pore volume according to the invention is formed by the addition of acoustically active fillers, the same is set by means of the addition of the quantity of acoustically active filler or fillers.

A further method for determining the pore volume according to the invention is the microscopic method. Here, the pore volume is determined by means of optical methods.

The specific density (g/cm³) of the pore volume according to the invention is different from the specific density of the B-stage binder and the fibres of the textile fabric, so that the sound waves pass through media of different specific density, at the respective boundary surfaces of which a refraction and/or reflection (complete or partial) takes place.

The acoustically active fillers used according to the invention are materials which, on account of their geometry and structure, enable a reduction of sound propagation and/or positively affect sound colouration, that is to say the frequency distribution of the sound emitted. Glass hollow spheres, hollow fibres, glass particles, cork particles, porous fillers, particles made from elastomers, cork, polystyrene particles, PU particles and foams may in particular be suitable for this. Preferably, the acoustically active fillers used according to the invention have a particle size of ≦300 μm, that is to say the D50 value or also median value is ≦300 μm. In addition, expanding agents which can generate gas-filled cavities in the binder material or in the textile surface or can enlarge existing cavities are suitable.

Porous fillers are understood to be those natural or synthetic fillers which have a pore volume of at least 10%. Examples for these are siliceous materials such as pyrogenic silicic acid, wet-precipitated silicic acid, zeolites, etc.

The term elastomers is understood to mean polymeric materials which have a rubber-elastic behaviour, that is to say can be repeatedly stretched to double their length at room temperature (20° C.) and, following the removal of the force necessary for the stretching, immediately assume approximately their initial length (according to Römpp “Chemielexikon”, 9th edition, “Elastomere”, pages 1105-1107). The elastomers mentioned there also comprise caoutchouc materials.

Insofar as the pore volume according to the invention is formed by the addition of acoustically active fillers, the same is set by means of the addition of the quantity of acoustically active filler/fillers.

The specific density (g/cm³) of the acoustically active filler is different from the specific density of the B-stage binder and the fibres of the textile fabric, so that the sound waves pass through media of different specific density, at the respective boundary surfaces of which a refraction and/or reflection (complete or partial) takes place.

The textile fabric according to the invention can be located in the interior or on at least one of the surfaces of the support material. The textile fabric can also be introduced into the support and pressed in during the production of the same. It can also be introduced and pressed in between individual layers of the support material or be applied onto the support as constituent or a laminate (e.g. HPL, CPL). Due to the inner structure of the textile fabric according to the invention, particular, particularly impact-sound insulating, properties of the composite material result.

Furthermore, the textile fabric according to the invention can also be of multiple-layer construction, that is to say two or more textile fabrics according to the invention with the same or different pore volumes can be combined. It is also possible that the textile fabric according to the invention is formed from only one layer, this layer having regions with different pore volumes in each case, so that the pore volume can also have a gradient over the thickness of the textile fabric. In a preferred embodiment, the pore volume in the outer regions of the textile fabric compared to the inner region of the textile fabric is higher by at least 10%, preferably by at least 15%, as seen relatively to one another.

Furthermore, the composite material according to the invention can also have one or a plurality of additional layers made from a cork and/or cork material. This additional cork layer can be cork furnished in one layer and/or cork furnished in multiple layers. The additional cork layer can also be applied as cork granulate (so-called cork grout).

The thickness of the respective additional cork layer is preferably between 0.1 mm and 3 mm, particularly preferably between 0.2 mm and 2 mm.

The additional cork layer is conventionally located between the support material and the textile fabric comprising an end-consolidated B-stage binder and/or on the side of the textile fabric which faces away from the support material and comprises an end-consolidated B-stage binder.

Both surfaces of the additional cork layer, at least however the surface of the additional cork layer facing the support, is provided with a B-stage binder which end-consolidates during the pressing of the composite material.

The additional cork layer effected an additional natural impact sound insulation and thermal insulation. Vibrations/oscillations in particular can be damped particularly well thereby.

A weight reduction of the composite material according to the invention, e.g. in the case of constant overall thickness, can be achieved by means of the additional cork layer.

The additional cork layer preferably has a flexural strength of 1.4 to 2 kg/cm.

The additional cork layer preferably has a density of 0.09 to 0.2 g/cm³, particularly of 0.1 to 0.15 g/cm³, without a binder in each case.

The flexural strength and density is determined according to DIN 18161.

The composite material according to the invention is suitable for floor coverings in particular. It can also be used for room elements of all sorts, such as e.g. ceiling and wall elements.

The composite material according to the invention stands out due to a high sound absorption coefficient α, which constitutes a measure for the absorbed sound intensity.

The sound absorption coefficient α is a measure for the absorbed sound intensity.

The sound reflection coefficient ρ is a measure for the reflected sound intensity.

The sound transmission coefficient τ is a measure for the sound intensity allowed through.

The sound dissipation coefficient δ is a measure for the “lost” sound intensity.

These relationships can be expressed as follows:

ρ+α=1

ρ+τ+δ=1

α=τ+δ

The first equation states that the sum of reflected and absorbed sound intensity, that is to say of sound reflection and sound absorption, always corresponds to the total sound intensity.

The last equation states that the absorbed sound intensity is comprised of the sound intensity allowed through (transmitted) and sound intensity “lost” (dissipated). A sound absorption thus arises by means of simultaneous sound transmission and sound dissipation.

The supports used in accordance with (i) are preferably materials based on wood, such as e.g. plywood or laminated wood, wood chip material, particularly chipboards and OSB (Oriented Strand Boards), wood fibre material, particularly porous fibreboards, vapour-permeable fibreboards, hard (high density) fibreboards (HDF) and medium density fibreboards (MDF), and Arboform. Furthermore, materials, particularly boards, made from paper, cork, cardboards, mineral constituents and/or so-called honeycombs are possible. The wood materials are usually board- or strand-like wood materials which are produced by mixing the various wood particle forms with natural and/or synthetic binders in the course of hot pressing.

The supports according to the invention additionally comprise materials made from wood fibre materials, cellulose fibres, natural fibres or mixtures thereof and a binder, the portion of the binder being more than 15% by weight. The materials are, if appropriate, reinforced by means of glass, basalt or synthetic fibres.

The papers are preferably papers based on natural, synthetic, mineral or ceramic fibres or also on mixtures of these fibre types.

The cardboards are preferably cardboards based on natural and/or synthetic fibres, these also comprising mineral and/or ceramic fibres as well as mixtures of these fibre types.

Mineral boards are preferably commercially available mineral cardboards with cardboard covering on both sides, gypsum fibreboards, ceramic fibreboards, cement or limestone boards. The boards can, if appropriate, be reinforced with natural and/or synthetic fibres, and they can also comprise mineral and/or ceramic fibres. The reinforcing fibres can be present in the form of filaments, monofilaments or as staple fibres.

In addition to the described materials, the support can also consist of cork or other plant-based materials.

The weight per unit area of the supports contained in the composite material is dependent on the end application and is subject to no particular limitation.

Further details on the suitable support materials and supports are described comprehensively in WO08/101678, to which reference is hereby made and the disclosure of which is also a part of this application with regards to the support materials and supports.

The textile fabrics used in accordance with (ii) are all structures which are produced from fibres and from which a textile surface has been produced by means of a surface-forming technology.

The textile fabrics to be provided with the B-stage binders can also fundamentally be used without binders, particularly chemical binders.

In order, however, to ensure the required strengths during further processing of the fabric, binders can also be introduced and/or known mechanical consolidation methods, preferably needling methods can be used. In addition to the possibility of a mechanical consolidation, e.g. by means of calendering or needling, mention may in particular also be made here of hydrodynamic needling. Chemical and/or thermoplastic binders are suitable as binders.

Preferably, the textile fabrics to be provided with the B-stage binder are pre-consolidated with a chemical binder, however. The binders used can be the same or different, but they must be selected from the group of binder systems compatible with the B-stage binder. The additional binder portion is at most 25% by weight, preferably 10% by weight or less, the minimum content is 0.5% by weight, preferably min. 1% by weight.

Preferably, the textile fabric is a non-woven and preferably consists of natural fibres and/or fibres made from synthetic or natural polymers, ceramic fibres, mineral fibres or glass fibres, it being possible for these to also be used in the form of mixtures. Particularly preferably, the non-woven consists of glass fibres, mineral fibres, polyester fibres or cellulose fibres. The term textile fabric also includes papers.

The textile surfaces made from mineral and ceramic fibres are aluminosilicate, ceramic, dolomite, wollastonite fibres or fibres of vulcanites, preferably basalt, diabase and/or melaphyr fibres, particularly basalt fibres. Diabases and melaphyrs are designated as palaeobasalts in summary and diabase is also often designated in German as Grünstein.

The mineral fibre non-woven can be formed from filaments, that is to say infinitely long fibres or from staple fibres. The average length of the staple fibres in the non-woven made from mineral fibres used according to the invention is between 5 and 120 mm, preferably 10 to 90 mm. In a further embodiment of the invention, the mineral fibre non-woven contains a mixture of endless fibres and staple fibres.

The average fibre diameter of the mineral fibres is between 5 and 30 μm, preferably between 8 and 24 μm, particularly preferably between 8 and 15 μm.

The weight per unit area of the textile fabric made from mineral fibres is between 15 and 500 g/m², preferably 40 and 250 g/m², this information relating to a fabric without binders.

Non-wovens in particular are preferred among the textile surfaces made from glass fibres. These are formed from filaments, that is to say infinitely long fibres or from staple fibres. The average length of the staple fibres is between 5 and 120 mm, preferably 10 to 90 mm. In a further embodiment of the invention, the glass fibre non-woven contains a mixture of endless fibres and staple fibres.

The average diameter of the glass fibres is between 5 and 30 μm, preferably between 8 and 24 μm, particularly preferably between 10 and 21 μm.

In addition to the previously mentioned diameters, so-called glass microfibres can also be used. The preferred average diameter of the glass microfibres is here between 0.1 and 5 μm. The microfibres forming the textile surface can also be present in mixtures with other fibres, preferably glass fibres. In addition, a layered structure made up of microfibres and glass fibres is possible.

The weight per unit area of the textile fabric made from glass fibres is between 15 and 500 g/m², preferably 40 and 250 g/m², this information relating to a fabric without binders.

Suitable glass fibres comprise those which were produced from A-glass, E-glass, S-glass, C-glass, T-glass or R-glass.

Of textile surfaces made from fibres made from synthetic polymers, non-wovens, particularly so-called spunbonds, that is to say spun non-wovens which are created by a random deposition of melt-spun filaments, are preferred.

Preferably, the spun non-wovens consist of melt-spinnable polyesters. In principle, all types of polyester material suitable for fibre production are considered as polyester material. Polyesters such as polyethylene terephthalate (PET) are particularly preferred.

The individual linear densities of the polyester filaments in the spun non-woven are between 1 and 16 dtex, preferably 2 to 10 dtex.

In addition to endless filaments (spunbond method), the textile surfaces can also be constructed from staple fibres or mixtures of staple fibres and endless filaments. The individual linear densities of the staple fibres in the non-woven are between 1 and 16 dtex, preferably 2 to 10 dtex. The staple length is 1 to 100 mm, preferably 2 to 50 mm, particularly preferably 2 to 30 mm. The textile fabric can also be constructed of different fibres of different materials in order to be able to achieve particular properties.

The weight per unit area of the textile fabric made from fibres made of synthetic polymers is between 10 and 500 g/m², preferably 20 and 250 g/m².

Non-wovens in particular are preferred among the textile surfaces made from cellulose fibres. These are formed from filaments, that is to say infinitely long fibres and/or from staple fibres. The average length of the staple fibres is between 1 and 25 mm, preferably 2 to 5 mm.

The average diameter of the cellulose fibres is between 5 and 50 μm, preferably between 15 and 30 μm.

Further details on the suitable materials for the textile fabrics are described comprehensively in WO08/101678, to which reference is hereby made and the disclosure of which is also a part of this application with regards to the textile fabric.

The textile fabric used in accordance with (ii) has at least one binder in the B-stage state.

Binders which are only partially consolidated or hardened and which can yet undergo an end-consolidation, for example by means of thermal post treatment, are understood as B-stage binders in the “B stage state”. B-stage binders of this type are e.g. described in detail in U.S. Pat. Nos. 5,837,620, 6,303,207 and 6,331,339 as well as in WO08/101678. The B-stage binders disclosed there are also subject matter of the present invention.

B-stage binders are preferably binders based on furfuryl alcohol formaldehyde, phenol formaldehyde, melamine formaldehyde, urea formaldehyde and mixtures thereof. One is preferably concerned with aqueous systems. Further preferred binder systems are formaldehyde-free binders. B-stage binders stand out on account of the fact that they can be subjected to a multi-stage hardening, that is to say following the first hardening or the first hardenings, still have enough binder action in order to be able to use these for further processing.

To achieve the B-stage, the textile fabric impregnated with the binder is dried under the influence of temperature without producing a complete curing. The required process parameters are dependent on the binder system chosen.

Conventionally, binders of this type are hardened following the addition of a catalyst at temperatures of approx. 350° F. in one step.

For forming the B stage, binders of this type are hardened, if appropriate after the addition of a catalyst. The hardening catalyst portion is up to 10% by weight, preferably 1 to 10% by weight (based on the total binder content). By way of example, ammonium nitrate, as well as organic aromatic acids, e.g. maleic acid and p-toluene sulphonic acid, as this allows reaching of the B-stage state faster. In addition to ammonium nitrate, maleic acid and p-toluene sulphonic acid are all materials suitable as hardening catalyst, which have a comparable acidic function. To achieve the B-stage, the textile fabric impregnated with the binder is dried under the influence of temperature without producing a complete curing. The required process parameters are dependent on the binder system chosen.

The lower temperature limit can be affected by the choice of the duration or by adding larger or more strongly acidic hardening catalyst.

The application of the B-stage binder to the textile fabric designated in (ii) can take place with the aid of all known methods. As described in WO08/101678, the binder can be applied, in addition to spraying on, soaking and pressing in, also by means of coating or foam application.

The textile fabric used in accordance with (ii) can, if appropriate, also have functional materials. The optionally used functional material can be applied at the same time as the B-stage binder, e.g. as mixture or as individual components or before or after the binder application. Insofar as the B-stage binder is applied by foam application, it is advantageous to apply the functional material with the foam or distributed in the foam or to apply the functional material onto the still fresh foam.

The required portion of the B-stage binder in the textile fabric is dependent on the free pore volume of the textile surface used. The quantity of B-stage binder applied is chosen in such a manner that the free pore volume present is not filled with binder completely. It has been shown that in the case of a B-stage binder portion of less than 35% by weight, a clearly improved acoustic damping occurs, as a sufficiently free pore volume remains.

Particularly preferred for the application according to the invention is a B-stage binder portion of 15-20% by weight, the percentage by weight values relating to the total weight of the, if appropriate pre-consolidated, textile fabric without functional materials. What is important about the present invention is the fact that, on account of the low B-stage binder portion in the textile fabric of less than 35% by weight, a porous material provided with a multiplicity of cavities is created, which produces an exceptionally positive effect on the sound damping in the laminate and on the “timbre” of the sound emitted.

The pore volume in the textile fabric can also be achieved by means of the addition of certain acoustically active fillers, that is to say fillers which effect sound absorption. In this case, the portion of the B-stage binder can be chosen to be higher and preferably lies between 60% by weight and 80% by weight.

The terms “acoustically active filler” and “acoustically active additive”, insofar as they are used in this description, are used synonymously.

A further possibility for increasing the pore volume, particularly the free pore volume, is the additional addition of hollow fibres into the textile fabric. The fibres can in this case be constructed of glass, mineral and/or synthetic materials, particularly synthetic organic polymers.

In the case of the textile fabric used in accordance with (ii), a functional material can, optionally, be present. Here, this is preferably flame retardant and materials for shielding against electromagnetic radiation.

The functional materials are bound in the B-stage binders. In a variant of the method, an additional binder is added for fixing the functional materials on the textile fabric. Here, preferably the same binder (B-stage binder) is chosen as is present in the textile fabric. The content or portion of functional material is determined by the subsequent use.

The flame retardants are inorganic flame retardants, organophosphorus flame retardants, nitrogen-based flame retardants or intumescent flame retardants. Halogenated (brominated and chlorinated) flame retardants can likewise be used, but are less preferred owing to their risk score. Examples for halogenated flame retardants of this type are polybrominated diphenylethers, e.g. decaBDE, tetrabromobisphenol A and HBCD (hexabromocyclododecane).

The nitrogen-based flame retardants are melamines and ureas.

The organophosphorus flame retardants are typically aromatic and alkyl esters of phosphoric acid. Preferred are TCEP (tris(chloroethyl) phosphate), TCPP (tris(chloropropyl) phosphate), TDCPP (tris(dichloropropyl) phosphate), triphenyl phosphate, trioctyl phosphate (tris-(2-ethylhexyl) phosphate).

The inorganic flame retardants are typically hydroxides, such as aluminium hydroxide and magnesium hydroxide, borates, such as zinc borate, ammonium compounds, such as ammonium sulphate, red phosphorus, antimony oxides, such as antimony trioxide and antimony pentoxide and/or layered silicates, such as vermiculites.

The materials for shielding against electromagnetic radiation are usually electrically conductive materials. Suitable materials are electrically conductive carbons such as carbon black, graphite and carbon nanotubes (C-nanotubes), conductive plastics or fibres made from metal or metal constituents. These can be constructed in the form of films, particles, fibres or wires, and/or textile fabrics made of the previously mentioned materials.

The application of the functional material takes place depending on the composition of the respective functional material by means of known technologies. Here also, the application can take place by means of rotary nozzle heads.

Preferably, the functional materials or the acoustically active filler which may be used is introduced together with the B-stage binder into the textile fabric. Preferably, the functional materials or the acoustically active filler is mixed with the B-stage binder and introduced together into the textile fabric or applied onto the textile fabric.

The functional materials can also be applied onto the textile fabric. For example, the functional materials can be applied onto the textile fabric between 2 drying systems of an impregnation installation.

For forming a pore volume gradient, the acoustically active filler is mixed together with the B-stage binder in various mixing ratios and then applied by means of multiple coating. Between the individual coating steps, the mixture of acoustically active filler and B-stage binder can be introduced into the textile fabric by means of rollers or roller pairs. Should the gradient be a free pore volume, the application quantity of B-stage binder per coating is varied or the concentration or the solid content of the B-stage binder is adjusted.

Insofar as the pore volume according to the invention is formed by the addition of acoustically active fillers, the pore volume is set by means of the addition of the quantity of acoustically active filler.

The specific density (g/cm³) of the acoustic filler is different from the specific density of the B-stage binder and the fibres of the textile fabric, so that the sound waves pass through media of different specific density, at the respective boundary surfaces of which a refraction and/or reflection (complete or partial) takes place.

Insofar as an additional cork layer is present, it is advantageous if the specific density (g/cm³) of the acoustic filler, of the B-stage binder, of the fibres of the textile fabric and of the cork material is different.

Insofar as the textile fabric has an additional decorative layer, such as e.g. a decorative paper or a printed non-woven, particularly a decorative layer created by means of direct or digital printing however, a conventional top and/or clear coat varnish can be applied as functional material. Decorative layers of this type, which are produced by means of direct or digital printing on textile fabrics consolidated by means of B-stage binders, are known e.g. from WO2008/101679A2. In this case, not only a composite material with improved acoustic damping behaviour is provided, but rather a decorative composite material, e.g. a laminate for floors is provided, which can be produced in a simple manner and has very good damping properties. In this embodiment, the following described additional elastomer layer which may be present is then advantageously installed between support material and textile fabric however.

The composite material according to the invention can additionally also have one or a plurality of elastomer layers, preferably at least one thermoplastic elastomer layer. The thickness of the elastomer layer is expressed as application quantity, this preferably corresponding to min 10 g/m² of elastomer.

This additional elastomer layer is conventionally installed between the support material and the textile fabric comprising an end-consolidated B-stage binder and/or applied onto the side of the textile fabric which faces away from the support material and comprises an end-consolidated B-stage binder. In a further embodiment of the invention, the elastomer layer can additionally function as a protective layer. Here, the elastomer layer can be printed on directly by means of direct or digital printing.

The term elastomers is understood to mean polymeric materials which have a rubber-elastic behaviour, that is to say can be repeatedly stretched to double their length at room temperature (20° C.) and, following the removal of the force necessary for the stretching, immediately assume approximately their initial length (according to Römpp “Chemielexikon”, 9th edition, “Elastomere”, pages 1105-1107). The elastomers mentioned there also comprise caoutchouc materials.

Thermoplastic elastomers, which are usually divided into the following groups, are understood to be a sub-group of the elastomers (designations in accordance with ISO 18064):
TPO=olefin-based thermoplastic elastomers, predominately PP/EPDM, e.g. Santoprene (AES/Monsanto)
TPV=olefin-based crosslinked thermoplastic elastomers, predominately PP/EPDM, e.g. Sarlink(DSM), Forprene(SoFter)
TPU=urethane-based thermoplastic elastomers, e.g. Desmopan, Texin, Utechllan (Bayer)
TPC=Thermoplastic copolyester, e.g. Hytrel (DuPont)
TPS=styrene block copolymers (SBS, SEBS, SEPS, SEEPS and MBS), e.g. Septon (Kuraray) or Thermoplast K (Kraiburg TPE)
TPA=Thermoplastic copolyamides, e.g. PEBAX (Arkema)

Suitable elastomers are in particular ACM, AU, BIIR, BR, CIIR, CM, CO, CR, CSM, EAM, ECO, EPDM-S, EP(D)M-P, EU, EVM, FKM, FVMQ, H-NBR, IIR, MVQ, NBR, NR(IR), OT, PNF, SBR, X-NBR (as defined in Römpp “Chemielexikon”, 9th Edition, “Elastomere”, pages 1106-1107).

Further subject matter of the invention is a method for producing a composite material with improved acoustic damping behaviour. This composite material consists—as explained previously—of a support and at least one textile fabric which contains an end-consolidated B-stage binder and has a pore volume of more than 20%.

The textile fabric can in this case be introduced into the support already during the production of the same or be applied onto the support material only after the finishing of the same or—in the case of multiple-layer systems—be introduced between the individual support layers. In this case, the textile fabric can also contain additional functional materials.

Subject matter of the invention is likewise a method for producing the composite material according to the invention, comprising the measures:
a) supplying support material,
b) supplying at least one textile fabric, the textile fabric having at least one binder in the B-stage state and which optionally has at least one functional material,
c) laminating the structure obtained according to steps a) and b) under the action of pressure and heat, so that the binder present in the B-stage is end-consolidated in the textile fabric,
d) if appropriate, application of further layers onto the laminate and drying if necessary,
   characterised in that the textile fabric supplied in b) has a pore volume of more than 20%, the lamination in (c) is carried out in such a manner that the textile fabric end-consolidated with B-stage binders has a pore volume in the region of more than 20% in the resulting composite material.

Insofar as no acoustically active fillers are added, the quantity of B-stage binders in b) is at most 35% by weight, preferably 15% by weight to 20% by weight, (in each case based on the pre-consolidated textile fabric without functional materials).

Insofar as acoustically active fillers are added, the quantity of B-stage binders in b) is more than 35% by weight, preferably 60% by weight to 80% by weight, (in each case based on the pre-consolidated textile fabric without functional materials).

The textile fabric can be located completely in the interior of the support material in this case. Alternatively, an asymmetric arrangement is also possible however and makes sense for many applications. In this case, the textile fabric is located at the edge or completely on the surface of the support to be formed. The same is true for the use of a plurality of fabrics which can be arranged at different points in the support or on one or both surfaces of the support. The layers optionally additionally applied in step d) are e.g. decorating papers and overlay papers which are laminated directly onto the acoustically active fabric.

The textile fabric can also be applied on the finished support or be introduced between a plurality of finished supports. Of course, a plurality of textile fabrics can also be introduced onto the surfaces of the support or between the supports. The layers optionally additionally applied in step d) are e.g. decorating papers and overlay papers which are laminated directly onto the acoustically active fabric.

In the event that a plurality of supports are pressed to form a laminate, the textile fabric or the textile fabrics can be arranged between the supports, applied on one or on both outer surfaces of the laminate or applied both between the supports and on one or both outer surfaces of the laminate.

In a variant, the application of a textile fabric according to step b) can also take place during the production of the support. In other words, instead of the finished support in step a), the support is only formed in step a).

Insofar as the composite material according to the invention should have an additional cork layer, this is applied—depending on the desired arrangement—onto the support material before step b).

The cork layer is preferably provided on both surfaces with a B-stage binder, at least however on the surface facing the support. The binder application can take place by means of all known methods, particularly by means of immersion of the cork layer into a binder bath or by means of standard coating methods. The binder application conventionally takes place in a special offline process. The surface facing the cork layer is preferably loaded with 10 g/m² to 50 g/m², whilst the surface facing away from the support accounts for 0 g/m² to 20 g/m².

Insofar as the composite material according to the invention should have one or a plurality of additional elastomer layers, these are applied—depending on the desired arrangement—onto the support material in accordance with step a) or before step b) and/or before or after the lamination in step c).

The formation of an additional elastomer layer usually takes place by means of the application as hot-melt and/or by means of blade coating. The formation in step a) can also take place directly on the support material. Alternatively, the elastomer layer can also already be present on the textile fabric supplied in step b).

The lamination of the structure obtained in accordance with the steps a) and b) in step c) takes place under the action of pressure and heat in such a manner that the binder present in the B-stage state is end-consolidated and, at the same time, the pore volume present is set to a value of more than 20%.

The lamination can take place by means of discontinuous or continuous pressing or by means of rollers. The methods are known to the person skilled in the art and are subject to no limitations whatsoever. It is merely to be ensured that the B-stage binder used is consolidated completely and the pore volume is set to the previously described value.

As already mentioned, the textile fabric is preferably introduced in accordance with step b) preferably in the interior of the support material, the optimum position of the textile fabric in the support material is dependent on the planned applications. Preferably, the textile fabric is located in the middle of the support to be formed, however.

In a further preferred configuration of the invention, the textile fabric is located in the support in the vicinity of one of the surfaces of the support. In a further alternative arrangement, the textile fabric can also be applied completely outside the support on its surface.

In a further preferred configuration of the invention, at least two textile fabrics are located in the support. In this case, the textile fabrics can also be applied unsymmetrically to the support centre, depending on the application, that is to say for example, one textile fabric can be arranged in the vicinity of the support centre and another can be arranged onto one of the support surfaces. Also, a combination of textile fabrics applied onto the surface and textile surfaces introduced into the carrier is possible. The possible arrangements are fundamentally not subject to any limitation.

The optional application of further layers in accordance with step d) is an option known to the person skilled in the art. Examples for this are the application of decorative laminates, e.g. CPL or HPL, decorative layers, papers, varnish and protective layers, etc. These additional layers, their application and machining or processing are likewise not subject to any limitations and are known to the person skilled in the art. Of course, these additional layers can for their part contain a textile fabric provided with a B-stage binder.

In addition to the previously described method, the composite materials produced with this method are also not known per se from the prior art.

Further subject matter of the invention is therefore a composite material comprising:
(i) at least one support material and
(ii) at least one textile fabric introduced into the support and/or applied onto the support, the textile fabric(s) having at least one end-consolidated B-stage binder,
(iii) optionally at least one functional material applied onto the surface of the textile fabric equipped with the B-stage binder or introduced into the textile fabric,
(iv) if appropriate, further layers, characterised in that
(v) the textile fabric end-consolidated with B-stage binders has cavities which correspond to a pore volume in the region of more than 20%.

This composite material also can comprise one or a plurality of cork layers between support material and textile fabric with end-consolidated B-stage binder, as described previously.

In the event that the laminate is formed of a plurality of supports, the textile surfaces can be located on one or both laminate surfaces, between the supports or both on the surfaces and in the interior of the laminate between the supports.

Insofar as the composite material according to the invention also has one or a plurality of additional elastomer layers, these are—as described previously—correspondingly constructed.

Further subject matter of the invention is therefore a composite material comprising:
a) at least two supports,
b) at least one textile fabric located between the supports and/or located on at least one of the outer surfaces of the support, which has at least one end-consolidated B-stage binder,
c) optionally at least one functional material applied onto the surface of the textile fabric equipped with the B-stage binder or introduced into the textile fabric,
d) if appropriate, further layers, characterised in that
e) the textile fabric end-consolidated with B-stage binders has cavities which correspond to a pore volume in the region of more than 20%.

The additional layers optionally applied in steps iv) and d) are in particular decorative layers, laminates, e.g. CPL or HPL, decorative papers or also varnish and protective layers, etc. These additional layers, their application and machining or processing are not subject to any limitations and are known to the person skilled in the art.

Of course, these additional layers can for their part contain a textile fabric provided with a B-stage binder. For example, decorative layers containing B-stage binders, CPL, HPL or other additional layers can be applied and laminated onto the support.

Insofar as the composite material according to the invention also has one or a plurality of additional elastomer layers, these are—as described previously—correspondingly constructed.

The invention therefore also comprises laminates which have the textile fabric according to the invention, that is to say a textile fabric, end-consolidated with a B-stage binder, with cavities which correspond to a pore volume in the region of more than 20%, and which can be applied as decorative additional layers onto a support. Here, in particular decorative layers, CPL, HPL or similar laminates are to be mentioned, which are selected depending on the application and are laminated onto the support by means of an adhesive.

Laminates of this type are known fundamentally. Laminates which contain a textile fabric are described comprehensively in WO08/101679 and WO08/101678, to which reference is hereby made and which are a constituent of this description.

CPL or HPL consist of a plurality of different layers, namely for the most part of kraft papers, decorative papers and overlay papers. By using textile fabrics, the construction can, as described in WO08/101679 and WO08/101678, be simplified and the laminate can be improved in terms of mechanical properties and fire characteristics. The use of the textile fabric according to the invention in these laminates additionally leads to a substantially improved acoustic damping behaviour and improved noise emission characteristic (frequency curve), which make themselves felt with respect to impact sound in the flooring sector in particular.

Further subject matter of the invention is therefore a laminate, particularly a decorative layer, an HPL or CPL, comprising at least one textile fabric, characterised in that the textile fabric end-consolidated with B-stage binders has cavities which correspond to a pore volume in the region of more than 20%.

A further embodiment also comprises laminates of this type, particularly CPL or HPL, which have one or a plurality of cork layers, as described previously. Further subject matter of the invention is therefore a laminate, particularly an HPL or CPL, comprising at least one textile fabric and a cork layer, characterised in that the textile fabric end-consolidated with B-stage binders has cavities which correspond to a pore volume in the region of more than 20% and the laminate is laminated onto the support by means of an adhesive.

Further subject matter of the invention is a composite material which comprises at least one laminate according to the invention, preferably a decorative layer according to the invention, an HPL or CPL.

The application of the laminate takes place by means of known methods under pressure and temperature with the aid of known adhesives. Alternatively, the laminate can also be achieved with the aid of an additional textile surface which is arranged between laminate and support and which contains a B-stage binder. The B-stager binder cures during the pressing process and effects the permanent adhesion of the laminate onto the support.

The composite material according to the invention and the laminate have exceptional sound-insulating and sound-damping properties. On account of the inner structure of the textile fabric in the composite material or laminates, there is a reduction of the sound propagation vertically and horizontally to the textile fabric introduced. Thus, there is an exceptional sound insulation e.g. to the floor covering underside. At the same time, the special structure of the textile surface reduces the sound conduction along the textile surface and particularly changes the sound colour, i.e. the frequency pattern of the sound. This positive effect particularly makes itself felt in the reduction or prevention of impact sound.

By using the textile surface according to the invention as well as suitable additional layers, the composite material acquires additional properties which are important for the application—as described above. For example, an improved impact behaviour of the composite materials can be achieved. The production of decorative surfaces is possible, which is of great importance in particular for floors or for furniture elements.

By using the textile surface according to the invention, particularly in combination with the previously described elastomer layer(s), on the one hand the impact behaviour is improved and at the same time, a further reduction of the impact sound is achieved.

Further subject matter of the invention is therefore the use of the composite materials and laminates according to the invention as floor covering or part of a floor covering. In addition, the materials and laminates can also be used as room or wall elements or parts thereof or be used in the furniture industry.

The following examples show the particular acoustic properties of the composite material according to the invention in an impressive manner, without limiting them, however.

What is claimed is:

1. A composite material comprising:
at least one support material and
(ii) at least one textile fabric, wherein the textile fabric has at least one end-consolidated B stage binder,
characterised in that
(iii) the textile fabric end-consolidated with B-stage binders has cavities which correspond to a pore volume in the region of more than 20%.

2. The composite material according to claim 1, characterised in that the textile fabric present in the composite material has up to 35% by weight, preferably between 15% by weight and 20% by weight of end-consolidated B-stage binders, (in each case based on the textile fabric without functional materials).

3. The composite material according to claim 1, characterised in that the textile fabric present in the composite material has at least one acoustically active filler which fills the pore volume and the quantity of end-consolidated B-stage binder is between 60% by weight and 80% by weight.

4. The composite material according to claim 1, characterised in that the textile fabric is located in the interior, on at least one of the surfaces of the support material and/or between individual layers of the support material.

5. The composite material according to claim 1, characterised in that the support material is materials based on wood, preferably plywood or laminated wood, wood chip material, particularly chipboards and OSB (Oriented Strand Boards), wood fibre material, particularly porous fibreboards, vapour-permeable fibreboards, hard (high density) fibreboards (HDF) and medium density fibreboards (MDF), and Arboform.

6. The composite material according to claim 1, characterised in that the textile fabric is a non-woven comprising natural fibres and/or fibres made from synthetic or natural polymers, ceramic fibres, mineral fibres or glass fibres, wherein these can also be used in the form of mixtures.

7. The composite material according to claim 6, characterised in that the textile fabric is a non-woven made of glass fibres, the weight per unit area of which is preferably between 15 and 500 g/m², a non-woven made from mineral fibres, the weight per unit area of which is preferably between 15 and 500 g/m², a non-woven made from polyester fibres, the weight per unit area of which is preferably between 10 and 500 g/m² or cellulose fibres and the fibres in the non-woven are present as filaments and/or staple fibres.

8. The composite material according to claim 1, characterised in that the B-stage binder is a formaldehyde-free binder or a binder which is subjected to a multiple-stage hardening in each case, preferably based on furfuryl alcohol formaldehyde, phenol formaldehyde, melamine formaldehyde, urea formaldehyde and mixtures thereof, wherein the aqueous systems are particularly preferred.

9. The composite material according to claim 1, characterised in that the textile fabric used in accordance with (ii) also has additional functional materials, preferably flame retardant and/or materials for shielding against electromagnetic radiation.

10. The composite material according to claim 1, characterised in that the textile fabric, which has at least one end-consolidated B-stage binder, is introduced into the support and/or is applied onto the support.

11. The composite material according to claim 1, characterised in that a functional material is applied onto the surface of the textile fabric equipped with the B-stage binder or introduced into the textile fabric.

12. The composite material according to claim 1, characterised in that the same additionally has one or a plurality of layers made from a cork and/or cork material, wherein the thickness of the respective additional cork layer is preferably between 0.1 mm and 3 mm.

13. The composite material according to claim 1, characterised in that at least two supports are present and textile surfaces according to (iii) are present between the supports and/or on the surfaces of the supports in each case.

14. The composite material according to claim 1, characterised in that the further layers are preferably decorative layers, CP laminates (CPL), HP laminates (HPL), decorative papers and/or varnish and protective layers.

15. The composite material according to claim 1, characterised in that the specific density (in g/cm³) of the pore volume is different from the specific density of the B-stage binder and the fibres of the textile fabric.

16. The composite material according to claim 3, characterised in that the acoustically active filler is formed from glass hollow spheres, hollow fibres, glass particles, cork particles, porous fillers, particles made from elastomers, cork, polystyrene particles, PU particles and foams.

17. The composite material according to claim 3, characterised in that the specific density (in g/cm³) of the acoustically active filler is different from the specific density of the B-stage binder and the fibres of the textile fabric.

18. The composite material according to claim 1, characterised in that the same has at least one additional elastomer layer.

19. The method for producing a composite material according to claim 1, comprising the measures:
a) supplying support material,
b) supplying at least one textile fabric, wherein the textile fabric has at least one binder in the B-stage state and which optionally has at least one functional material,
c) laminating the structure obtained according to steps a) and b) under the action of pressure and heat, so that the binder present in the B-stage is end-consolidated in the textile fabric,
d) if appropriate, application of further layers onto the laminate and drying if necessary,
characterised in that the textile fabric supplied in b) has a pore volume of more than 20%, the lamination in (c) is carried out in such a manner that the textile fabric end-consolidated with B-stage binders has a pore volume in the region of more than 20% in the resulting composite material.

20. A method according to claim 19, characterised in that insofar as no acoustically active additives are added, the quantity of B-stage binders in b) is at most 35% by weight, preferably 15% by weight to 20% by weight, (in each case based on the pre-consolidated textile fabric without functional materials).

21. The method according to claim 19, characterised in that insofar as acoustically active additives are added—the quantity of B-stage binders in b) is more than 35% by weight, preferably 60% by weight to 80% by weight, (in each case based on the pre-consolidated textile fabric without functional materials).

22. The method according to claim 19, characterised in that the lamination takes place by means of discontinuous or continuous pressing or by means of rollers.

23. The method according to claim 19, characterised in that the application of a textile fabric according to step b) can also take place during the production of the support.

24. A decorative layer, preferably a CP laminate (CPL) and/or HP laminate (HPL), comprising at least one textile fabric, characterised in that the textile fabric end-consolidated with B-stage binders has cavities which correspond to a pore volume in the region of more than 20%.

25. The decorative layer according to claim 24, characterised in that the same additionally has one or a plurality of layers made from a cork and/or cork material, wherein the thickness of the respective additional cork layer is preferably between 0.1 mm and 3 mm.

26. A floor covering or part of a floor covering comprising a composite material according to claim 1.
